(19) United States
(12) Patent Application Publication
(10) Pub. No.: US 2025/0177847 A1
(43) Pub. Date: Jun. 5, 2025

(54) CARD DISCARDING DEVICE FOR TABLETOP GAME

(71) Applicant: ANGEL GROUP CO., LTD., Shiga (JP)

(72) Inventor: Yasushi SHIGETA, Shiga (JP)

(21) Appl. No.: 19/047,113

(22) Filed: Feb. 6, 2025

Related U.S. Application Data
(63) Continuation of application No. 18/882,157, filed on Sep. 11, 2024.
Application No. 18/882,157 is a continuation of application No. 15/518,573, filed on Apr. 12, 2017, now Pat. No. 12,115,438.

(30) Foreign Application Priority Data
Oct. 14, 2014 (JP) 2014-223628

(51) Int. Cl. A63F 1/06; A63F 1/10; A63F 1/12; G07F 17/32

(52) U.S. Cl. CPC A63F 1/06; A63F 1/10; A63F 1/12; G07F 17/32

(57) ABSTRACT

A card disposal apparatus, including an ejection port for disposing of cards after the game, a disposal card receiving board that receives the cards from the ejection port, disposal card information acquisition means that acquires information about number (rank) from the cards put in the ejection port, group information acquisition means that acquires group information from the cards to be disposed of, a counter for the cards as number count means that counts the number of the disposal cards put in the ejection port, deck check means that checks whether all cards to be disposed of are complete in terms of 52×8 decks=416 in the case of a set of 8 decks of cards, and output means that outputs a check result. Void holes are provided on the cards to be disposed of, and ensure that the cards are perfectly disposed of without being unfairly reused.

### CROSS REFERENCE TO RELATED APPLICATIONS

This application is a continuation of U.S. patent application Ser. No. 18/882,157 filed Sep. 11, 2024, which is a continuation of U.S. patent application Ser. No. 15/518,573 filed Apr. 12, 2017 (now U.S. Pat. No. 12,115,438), which is a national-phase application under 35 USC § 371 of International Pat. App. PCT/JP2015/005196 filed Oct. 14, 2015, which claims priority to JP Pat. App. 2014-223628 filed Oct. 14, 2014. The contents of each application is herein expressly incorporated by reference.

### TECHNICAL FIELD

The present invention relates to a card disposal apparatus for a table game that has a function to prevent cards used in a card game from being unfairly taken out and to detect whether a predetermined number of cards have been surely disposed of, and particularly, to an apparatus that allows cards that should be disposed of, to be surely contained in a disposal card stocker.

### BACKGROUND ART

There is a possibility of an unfair behavior in which cards are swapped on a game table during a game for achieving a self-advantageous game. International Pub. WO 2013/172038 discloses a prevention apparatus against this kind of unfair behavior. In the literature, determination is made as to whether the number of the cards having appeared in the table game coincides with the number of the cards used in each game. The cards having appeared in the table game are put in an ejection port, and void holes or cutouts are provided on the used cards. The void cards are received by a disposal card carton, and are disposed.

In the case where the void holes or the cutouts are provided on the cards used in the table game and the void cards are received by an individual disposal card carton and are disposed of, there is a problem in that a labor is required for the exchange of the carton and the disposal for each carton, and a labor is required for a management under which the disposal for each carton is surely performed.

The conventional apparatus confirms whether cards equivalent to a predetermined number of decks contained in a dealing shoe on the game table (for example, in the case of using 8 decks, the number of the cards is 52×8 decks=416) are complete. Then, the cards are put in the disposal card carton and are disposed of. Therefore, there is a problem in that a labor is required for the exchange of the carton and the disposal for each carton, and a labor is required for a management for each carton under which the disposal for each carton is surely performed.

### SUMMARY OF INVENTION

The present invention has been made in such a context, and an object of the present invention is to provide a card disposal apparatus that has a structure of checking whether the cards to be disposed of after the use on the game table are complete in terms of a predetermined number (for example, in the case of using 8 decks, the predetermined number is 52×8 decks=416), and then making the cards to be sequentially contained in multiple pockets of a disposal card stocker of the card disposal apparatus, and that realizes an absolute disposal operation by the multiple pockets partitioned by multiple partitions. Further, for avoiding the cards from being reused after the number check, the disposal card stocker includes a locking device. Thereby, it is possible to absolutely prohibit an unfair reuse of the cards.

For solving the conventional problem, a card disposal apparatus in the present invention is a card disposal apparatus that disposes of cards dealt on a game table from a dealing shoe, after use in a game, the card disposal apparatus including: an ejection port that receives the cards to be disposed of; a counter that counts and stores the number of the cards received through the ejection port; a disposal card stocker that receives the cards put in the ejection port; and deck check means that determines whether all cards put in the ejection port are complete in terms of a number equivalent to a predetermined number of decks, the disposal card stocker including multiple pockets that are partitioned by multiple partitions, each of the pockets having a structure capable of sequentially receiving cards that are dealt from the dealing shoe, that are used in the game and that are collected, and capable of receiving all cards that remain in the dealing shoe without being used, the deck check means totally counting the number of cards that are used in each game and that are counted by the counter and the number of the cards that remain in the dealing shoe without being used, and determining whether the disposed cards are complete in terms of the number equivalent to the predetermined number of decks, the multiple pockets of the disposal card stocker having structures capable of moving relative to a main body of the apparatus and capable of receiving different sets of cards respectively, and further having structures of being detachable from the main body of the apparatus.

The card disposal apparatus for the table game in the present invention provides a card disposal apparatus that does not require the management of an individual carton because of the multiple pockets partitioned by the multiple partitions, and that realizes an absolute disposal operation of the cards that should be disposed of. Further, for avoiding the cards from being reused after the number check, the disposal card stocker includes a locking device. Thereby, it is possible to absolutely prohibit an unfair reuse of the cards.

### BRIEF DESCRIPTION OF DRAWINGS

FIG. 1 is a plan view of a table game system in an embodiment of the present invention.

FIG. 2 is a plan view of a cut card in the embodiment of the present invention.

FIG. 3 is a perspective view of a card disposal apparatus of the table game system in the embodiment.

FIG. 4 is a sectional side view of the card disposal apparatus in the embodiment of the present invention. FIG. 4 is a diagram showing a relation between a code constituted of marks M printed as card information and output waveforms of two UV sensors of a card information acquisition sensor.

FIG. 5A, FIG. 5B, and FIG. 5C are perspective views showing the function of a weight of the card disposal apparatus.

FIG. 6 is a plan view of a state where a lid of the disposal card stocker in the embodiment is removed.

FIG. 7 is a plan view of the lid of the disposal card stocker in the embodiment.

FIG. 8 is a plan view of a card in Embodiment 1 of the present invention.

FIG. 9 is a plan view showing a card in a state where a void hole is provided by void means (punch device).

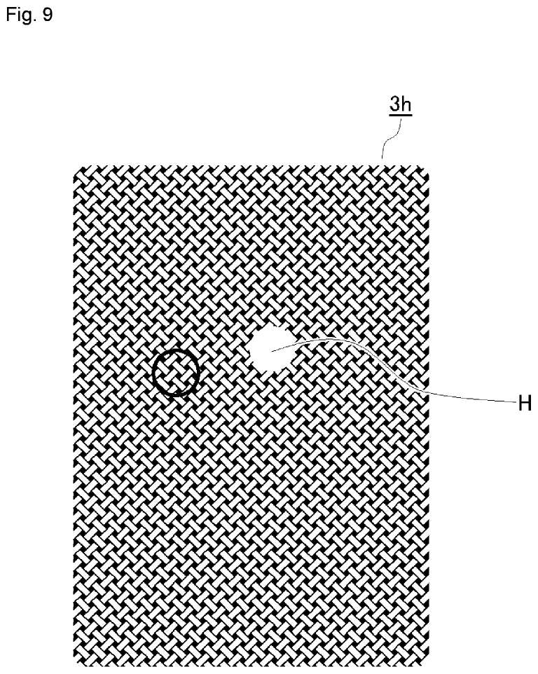

### DESCRIPTION OF EMBODIMENTS

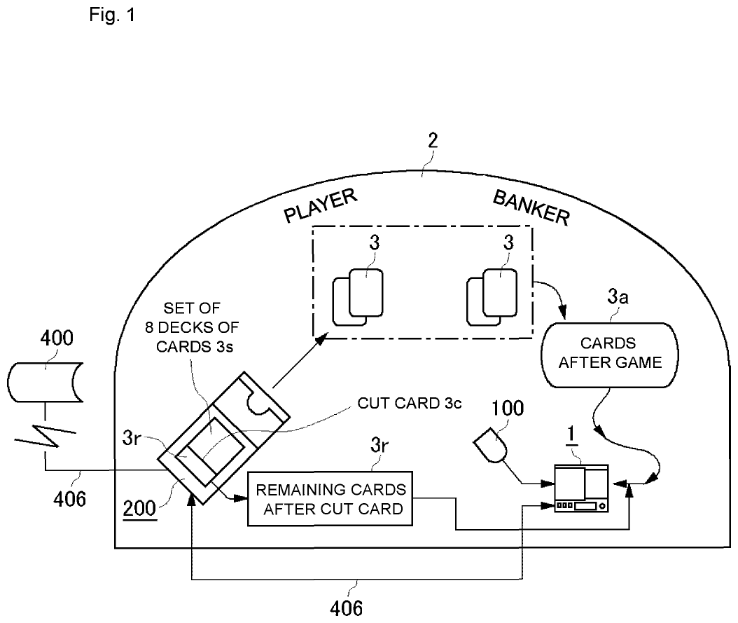

Embodiment 1 of the present invention will be described with reference to the drawings. In FIG. 1, a card disposal apparatus 1 that is a card disposal apparatus for a table game in Embodiment 1 of the present invention is provided on a game table 2 or is arranged on a side surface of the game table 2. The game table 2 shown in FIG. 1, which is shown in a simplified figure, is a game table for an ordinary baccarat game. As is well known, the baccarat game is played by a player and a banker. On the game table 2, a dealing shoe 200 is provided. The dealing shoe 200 is a source of card 3, and the cards 3 fed from the dealing shoe 200 are dealt to the player. Then, after the finish of a game, the disposal process for the cards 3 is performed by the card disposal apparatus 1. Embodiment 1 is a card disposal apparatus that disposes of the cards 3 contained in the dealing shoe 200 placed on the game table 2 and manually dealt on the game table 2 by a dealer or the like, after the use in the game, and is a card disposal apparatus including, as basic constituents, a set of multiple decks of cards 3 (ordinarily, 6, 8 or 12 decks) contained in the dealing shoe 200 and the card disposal apparatus 1 that disposes of collected cards 3a.

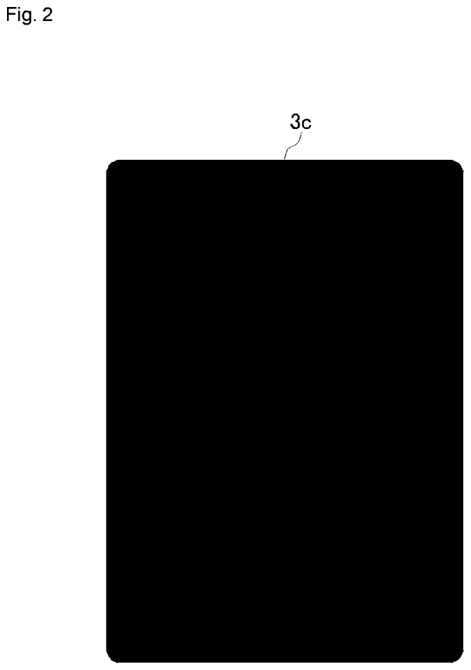

A cut card 3c is inserted into a set 3s of the cards 3 before the setting in the dealing shoe 200 on the game table 2. The cut card 3c is inserted into a latter part (the rest is about one-fourth or one-fifth) of the set 3s of the cards 3, when the set 3s of the cards 3 is used in the game, and is used for finishing the game on the game table 2 in a state where about 20 to 40 cards 3 remain in the dealing shoe 200, in order to prevent the player from predicting the ranks of a small number of remaining cards by counting the ranks of the cards dealt during the game (see FIG. 1). FIG. 2 shows a plan view of the cut card 3c.

The card disposal apparatus 1 has a structure capable of sequentially receiving the cards 3a that are used in each game and that are collected, and receiving all cards 3r that remain in the dealing shoe 200 without being used, when the game is stopped at a predetermined timing after the cut card 3c appears from the dealing shoe 200 (at a timing of the finish of the next game or 2-3 games after the cut card 3c is drawn). The card disposal apparatus 1, with card desk check means described later, totally counts the number of the cards 3a after the use in each game and the number of the cards 3r that are not used and remain in the dealing shoe 200 after the cut card 3c appears from the dealing shoe 200, and determines whether all disposed cards are complete in terms of the number equivalent to the predetermined number of decks.

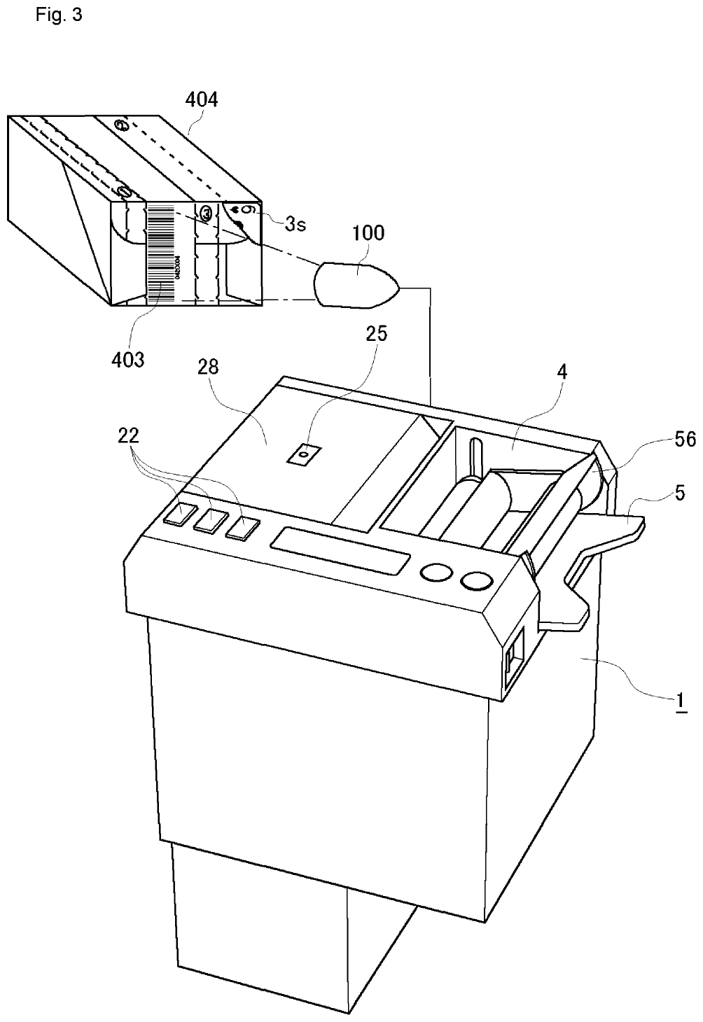

Next, the detail of the card disposal apparatus 1 will be described with FIGS. 3 to 7. The card disposal apparatus 1 includes an ejection port 4 for disposing of the cards 3a after the game that are dealt on the game table 2 for each game. The card disposal apparatus 1 is configured to include a disposal card receiving board 5 that receives the disposal-target cards 3a from the ejection port 4, disposal card information acquisition means 6 that acquires the information about number (rank) and kind (suit) from the cards 3a put in the ejection port 4, group information acquisition means 7 that acquires group information from the disposal cards 3a, a counter 8 for the cards as count means that counts the number of the disposal cards 3a put in the ejection port 4, authenticity determination means 9 that compares the group information of the cards acquired by the group information acquisition means 7 to predetermined group information, and determines whether the group information of the cards coincides with the predetermined group information, and output means 10 that outputs the determination result by the determination means. The card disposal apparatus 1 includes deck check means 13 that integrates the information acquired by the disposal card information acquisition means 6 and the information of the counter 8, measures the number of the cards 3 at least for each number (rank), and determines whether the number of the cards 3 put in the ejection port 4 is complete in terms of a predetermined number. The card disposal apparatus 1 includes a control device 14 that controls the whole operation, and each means described above is arranged in the control device 14, to control each operation. The control device 14 is constituted by electronic circuits including a microcomputer, a memory and the like, and includes constituents of an ordinary computer, as exemplified by a CPU, a ROM and a RAM. By executing a program stored in memories such as the ROM, the control device 14 controls the whole of the apparatus, and performs necessary processes.

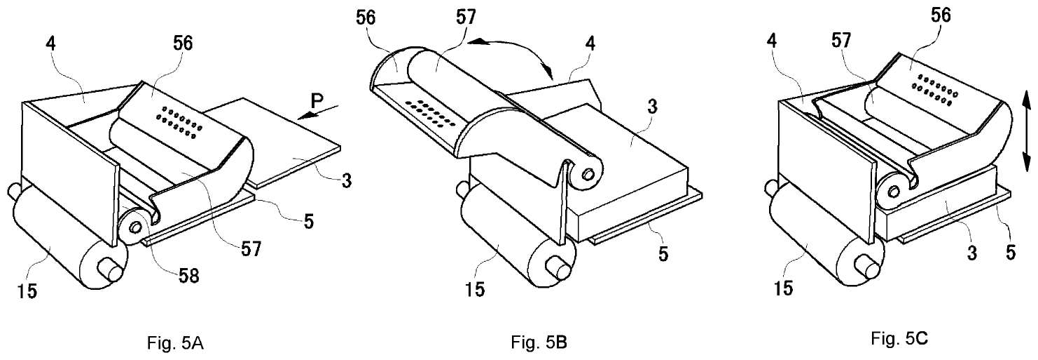

The detail of the card disposal apparatus 1 will be further described. The cards 3 after the use in the game are inserted into the ejection port 4, and are disposed of. A weight 56 is arranged above the disposal card receiving board 5 that receives the disposal-target cards 3. The weight 56 is provided for pressing the cards 3 onto the disposal card receiving board 5 and assisting in surely feeding the cards 3 toward a feeding roller 15, even when the disposal-target cards 3 are folded during the game, and is configured to press both ends of the cards 3 downward by weight rollers 57, 58. Although the ejection port 4 receives the cards 3 from the direction indicated by an arrow P as shown in FIG. 5(a), the weight 56 has a structure capable of moving upward (this state is shown in FIGS. 5(b) and 5(c)) such that the cards 3 in a bundle state can be also received.

The feeding roller 15 for feeding, one by one, the disposal cards 3 placed on the disposal card receiving board 5 by hand is provided below the disposal card receiving board 5. The feeding roller 15 is rotated and driven by a drive motor 16. As the drive motor 16, a stepping motor is used. When the cards 3 are placed on the disposal card receiving board 5, a card sensor 17 detects this, the control device 14 controls the drive motor 16, and the feeding roller 15 rotates. In this way, the cards 3 on the disposal card receiving board 5 are fed by the feeding roller 15. The cards 3 fed from the feeding roller 15 are further transferred toward the direction (arrow D) of a disposal card stocker 19, by a pair of transferring rollers 18. The transferring rollers 18 are driven and controlled by a transferring motor 16f, and the driving speed is set such that the cards 3 are transferred at a higher speed than a speed at which the cards 3 are transferred by the feeding roller 15. Therefore, the cards 3 are surely transferred in the direction (arrow D) of the disposal card stocker 19, such that the cards 3 are pulled by the transferring rollers 18. The cards 3 to be transferred pass through a group information acquisition sensor 20 and two card information acquisition sensors 21 in the middle of the transfer, and here, the information of the cards 3 are detected and acquired.

The group information acquisition sensor 20 is connected with the group information acquisition means 7 that acquires the group information from the cards 3. The card information acquisition sensor 21 is connected with the disposal card information acquisition means 6 that acquires the information about the number (rank) from the cards 3, and the information about the number (rank) is acquired. The cards 3 to be transferred to the disposal card stocker 19 are detected by the counter 8 connected with the card sensor 17, and the number of the passing cards 3 is counted. The signal of the group information acquisition sensor 20 is transmitted to the group information acquisition means 7. The authenticity determination means 9 compares the group information of the card 3 acquired by the group information acquisition means 7, to the predetermined group information that is previously stored, and determines whether the group information of the card 3 coincides with the predetermined group information. When the group information of the card 3 does not coincide with the predetermined group information, the authenticity determination means 9 determines that the card 3 is a fake card, and the control device 14 lights an indication lamp 22 through the output means 10 that outputs the determination result, and sends the existence of the fake card to a management division 400 or the like of a casino or the like, through a communication line 406.

When the authenticity determination means 9 determines that the card 3 is a fake card, the control device 14 transmits the information to void means 26, and the void means 26 punches, in the card 3, one or two special void holes H indicating that the card 3 is abnormal. The card 3 after the determination by the authenticity determination means 9 is transferred to the disposal card stocker 19 through an opening 19M. The card disposal apparatus 1 has a disposal card passage structure that is closed such that the card cannot be taken off until the card 3 reaches a pocket 19c for the disposal card in the disposal card stocker 19. The card 3h to be disposed of, in which the void hole H is punched in order to avoid the use for another purpose, falls in the pocket 19c for the disposal card, together with void waste.

When the card 3 is transferred toward the disposal card stocker 19, the card information acquisition sensor 21 and the group information acquisition sensor 20 each acquire the information. After the determination that the card 3 is an authentic card, the void means 26 bores the void hole H allowing the card 3 not to be used afterward, in the card 3. Therefore, the card 3 to be transferred toward the disposal card stocker 19 passes through the void means 26. The void means 26 bores the void hole H in the card 3, by hole boring means (a punch and die, or the like). The card 3h having the void hole H bored falls in the pocket 19c for the disposal card in the disposal card stocker 19. Although the void hole H is bored by the void means 26 in the embodiment, a cutout may be provided at a corner of the card 3, or a void mark may be given by printing means using a known stamp of laser. Thus, for avoiding the reuse of the card after the disposal process and the check, the void hole or the void mark is provided on the card, so that an unfair reuse of the card is absolutely prohibited.

The disposal card stocker 19 is provided with a lid 19f that allows the disposal card 3h to be taken off afterward. The lid 19f is provided with disposal card locking means 27, which prevents the disposal card 3h from being unfairly taken off during the movement of the disposal card stocker 19. When the disposal card stocker 19 is detached from the main body of the card disposal apparatus 1, a cover 28 for takeoff, which is provided at an upper part of the card disposal apparatus 1, is opened. The cover 28 is provided with an unfair-behavior prevention device 25 that restricts the operation of the cover 28, and the control device 14 controls the unfair-behavior prevention device 25 such that only an authorized operator can open the cover 28 using a key or the like. The disposal card locking means 27 performs the lock control of the opening and closing of the lid 19f, so that only the authorized operator can open the lid 19f using the key or the like, and prevents an unfair takeoff of the disposal card 3h from the disposal card stocker 19. The shape of the lid 19f is designed such that an interspace R is made between the main body side and lid 19f of the disposal card stocker 19, for allowing the card 3h transferred by the transferring rollers 18 to be received and put in the pocket 19c.

Next, the deck check means 13 will be described. Ordinarily, multiple decks (4, 6 or 8 decks) of cards are set in the dealing shoe 200 (electronic shoe) placed on the game table 2. The set 3s of the cards is given in a state (package 404) where the multiple decks of cards are shuffled and packed, and each different bar code 403 is provided on the package 404 (see FIG. 3). From the bar code 403, the ID information identifying an individual set 3s of cards is read by a reading device 100 arranged on the game table 2, and from the ID information, the set 3s of cards to be used in the game is identified. Then, the set 3s of cards is set in the dealing shoe 200, and is given for each game. In the set 3s of cards set in the dealing shoe 200, all cards are not used. At the beginning of each game, the cut card (reference character 3c in FIG. 2) is inserted into the set 3s of multiple decks (4, 6 or 8 decks) of cards, for a reason of the security of the game. When the cut card 3c appears, the remaining cards 3r in the dealing shoe 200 are not used any more. All the remaining cards 3r are put in the ejection port 4 for disposal.

All the remaining cards 3r are put in the ejection port 4 for disposal, and from the remaining cards 3r, the information about the number (rank) is acquired by the disposal card information acquisition means 6. The deck check means 13 integrates the information of the counter 8 for the cards as the count means, with the information about the number (rank) acquired from the remaining cards 3r by the disposal card information acquisition means 6 and at least the information about the number (rank) acquired from each card 3a already used in each game, and counts the number of the cards for each card number (rank). Then, the deck check means 13 determines whether all cards placed on the game table and put in the ejection port 4 are complete in terms of the number equivalent to the predetermined number of decks for all numbers (ranks) (416 cards, ace to king, 4 kinds×8 decks, for example).

The total number of the cards 3 to be used in the table game (ordinarily, any of 4, 6, 8, 10 and 12 decks) is previously determined in the casino or the like. For example, in the case of 8 decks, the number of the cards 3 is 52?8 decks=416, and 8 cards are used for each card kind having the same suit and rank. In the deck check means 13, the control device 14 determines whether the number of cards is complete for each card kind, and the output means 10 to output the result lights the indication lamp 22 in a color that is different depending on the result. At the same time, communication means 406 sends the count result of the cards 3 to the management division 400 or the like of the casino or the like.

To sum up the cards 3h already disposed of in the pocket 19c of the disposal card stocker 19 and the cards 3r placed collectively on the disposal card receiving board 5 in the ejection port 4 without being used in the game (the cards 3r are also preserved in the pocket 19c of the disposal card stocker 19), all the cards initially set in the dealing shoe 200, whose number is 52?8 decks=416, are preserved in the pocket 19c. In the case of the set 3s of 8 decks of cards, the deck check means 13 checks whether 32 cards (416 cards in total) exist for each of the 13 ranks of cards, based on the information acquired from all cards whose number is 52?8 decks=416. In this way, the deck check means 13 confirms that the 416 cards are complete.

The use of the set (for example, 8 decks) of cards in the dealing shoe 200 is finished, and all cards are preserved in the pocket 19c, as described above. Thereafter, the bar code 403 attached to the package 404 that packs the set 3s of cards for identifying the set 3s of cards in the pocket 19c is inserted into the pocket 19c. In this case, not only the bar code 403 but also the package 404 may be inserted into the pocket 19c. When the package 404 and the bar code 403 are inserted into the pocket 19c, trash is not made around the table in the casino, and there is an advantage in terms of arrangement. The package 404 and the bar code 403 enter the pocket 19c through a slit 28s formed on the cover 28 for takeoff and a slit 19s provided on the lid 19f. The cover 28 for takeoff may have a structure in which the lock is unlocked and the cover 28 is opened upward, and the package 404 and the bar code 403 may enter the pocket 19c through the slit 19s. Thus, the use of the set (for example, 8 decks) of cards in the dealing shoe 200 is finished, all cards are preserved in the pocket 19c, and the bar code 403 used for identifying the set 3s of cards is also put in the same pocket 19c.

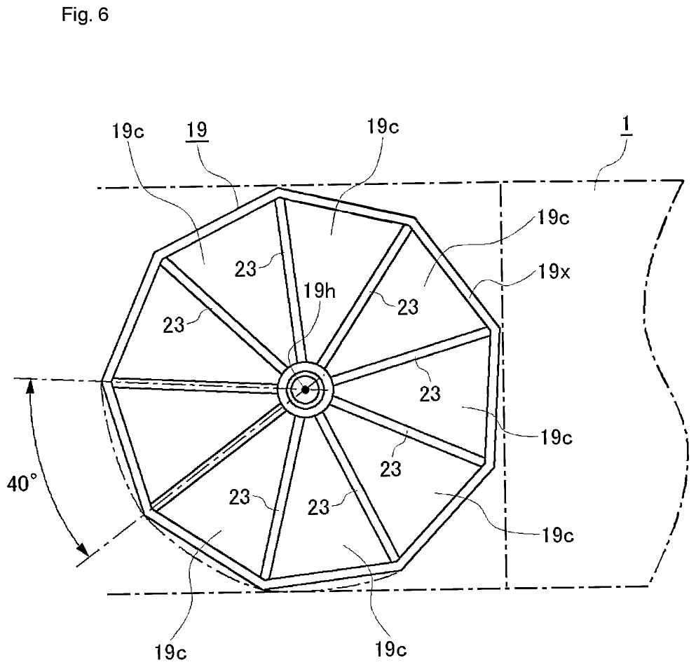

When all cards of the set (for example, 8 decks) in the dealing shoe 200 are preserved in the pocket 19c and the bar code 403 is put in, the dealer actuates a rotation device 28 (a stepping motor or the like) through a switch (not illustrated) or the like, and the disposal card stocker 19 rotates around a rotation shaft 28r by 40 degrees (arrow W). The disposal card stocker 19 is sectioned such that 9 pockets 19c are provided. When the disposal card stocker 19 rotates by 40 degrees (arrow W), an adjacent empty pocket 19c (see FIG. 6) is located at a position enabling to receive the next set 3s of cards to be disposed of.

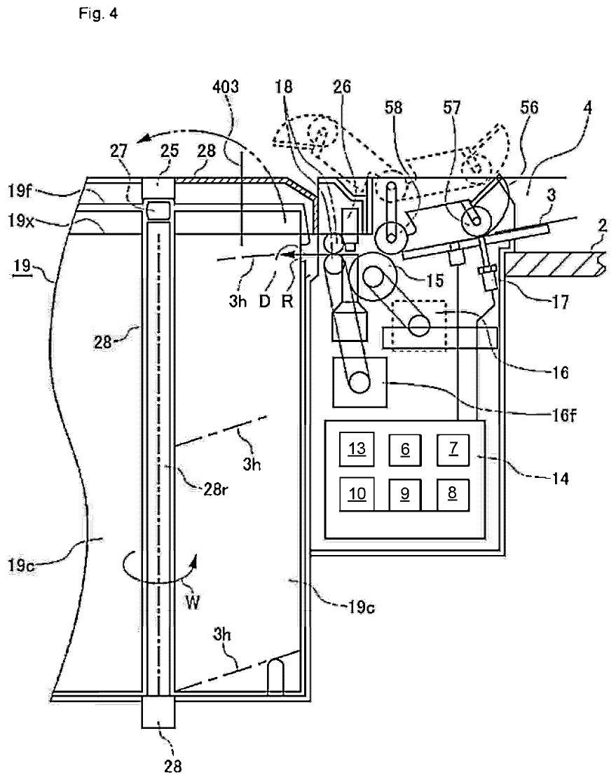

The disposal card stocker 19 includes the multiple pockets 19c partitioned by multiple partitions, and each of the pockets 19c has a size enabling to sequentially receive cards 3h (for example, 416 cards) that are dealt from the dealing shoe, that are used in the game and that are collected. Then, when the game is stopped at the predetermined timing, the disposal card stocker 19, in which all cards of the set 3s in the dealing shoe 200 and the bar code 403 are put, rotates around the rotation shaft 28r, so that the adjacent empty pocket 19c reaches the position for receiving the disposal cards 3h (the state in FIG. 4). The pockets 19c have a structure capable of sequentially receiving sets 3s of cards to be disposed of and receiving 9 sets. At the center of the disposal card stocker 19, a shaft hole 19h that receives the rotation shaft 28r is provided. The disposal card stocker 19 rotates while being guided by the shaft hole 19h.

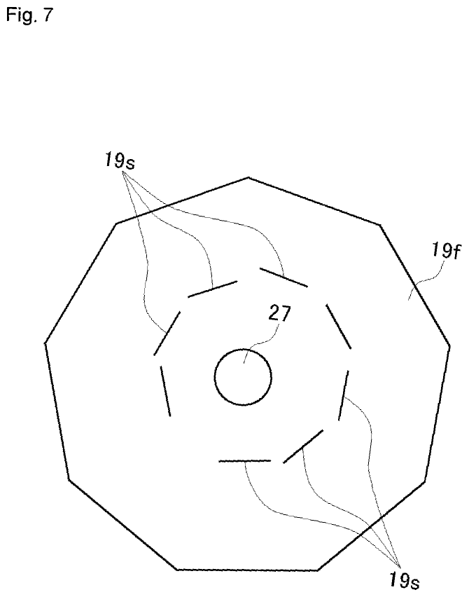

When the disposal card stocker 19 is detached from the main body of the card disposal apparatus 1, the cover 28 for takeoff, which is provided at the upper part of the card disposal apparatus 1, is opened, and the disposal card stocker 19 is taken off upward while being guided by the shaft hole 19h. Since the unfair-behavior prevention device 25 that restricts the operation of the cover 28 is provided on the cover 28, only the authorized operator can perform the takeoff. In the card stocker 19 detached from the main body of the card disposal apparatus 1, an open part 19x at an upper part is covered with the lid 19f (FIG. 7), and therefore, the cards 3h to be disposed of cannot be taken off. The disposal card locking means 27 locks the lid 19f to the card stocker 19, and only the authorized operator can open the lid 19f using the key or the like and can dispose of the disposal cards 3h.

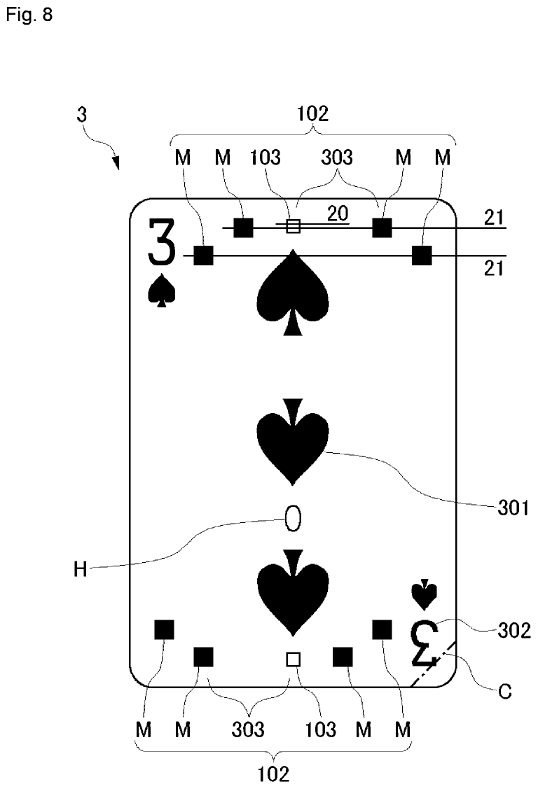

Next, the card 3 to be used in the table game in the embodiment of the present invention will be described with FIG. 8. On the card 3, codes 102 that are codes of the number of the card 3 and that are constituted of ordinarily invisible marks M are provided at the upper side and lower side of the card 3, in a point-symmetric manner. The code 102 is constituted of the combination of the number and arrangement of multiple marks M printed with an infrared light sensitive ink or ultraviolet light sensitive ink that is invisible under daylight. Further, on the card 3, group code information 103 that is a code of the information indicating the authenticity of the card, that is arranged by printing or the like in an ordinarily invisible state (for example, an ultraviolet light sensitive ink), and that is used as an authenticity determination code is provided. The code 102 and the group code information 103 are arranged at least at two spots on the card 3, and are arranged at positions that are point-symmetric with respect to the center of the card 3.

The codes 102 are read by the two card information acquisition sensors 21 constituting the card information acquisition sensors 21. The card information acquisition sensor 21 is configured to output an output signal when detecting the marks M (a known ultraviolet light sensitive optical sensor or the like is used). FIG. 8 shows a relation between the outputs of ON signals of the two UV sensors (the electric signal output when the code 102 constituted of the marks M is read) and the marks M. A predetermined combination of the marks M can be identified, based on the comparison result of relative changes in the outputs of the ON signals of the two UV sensors for the codes 102 constituted of the marks M. As a result, in the embodiment shown in FIG. 8, 4 kinds of codes can be configured as the combinations of 2 marks on upper and lower rows, and when 4 rows are printed, 256 kinds of codes can be configured because of the fourth power of 4 kinds. Each of the 52 card kinds of the trump cards is assigned to one of the 256 kinds of codes, and the assignment is stored in the memory or program, as a comparison table. The disposal card information acquisition means 6 identifies each code 102, and thereby, can identify at least the number (rank) of the card 3, based on the previously determined comparison table (not illustrated). It is preferable that the codes 102 be printed with a coating material that is visualized by receiving ultraviolet light, and be printed at positions where the codes 102 do not overlap with kind signs 301 and indexes 302 of the card 3. Further, a space part 303 is provided among the code 102, the group code information 103 and the edge of the card 3. Further, the group code information 103 may be printed at the same spot together with the code 102, with an ink indicating the group code information.

Next, the authenticity determination means 9 that determines the authenticity of the card based on the information about the authenticity of the card 3 will be described. On the card 3 that is the target of the authenticity check, the group code information 103 as the group information that is a code of the information indicating the authenticity of the card 3 and that is configured in an ordinarily invisible state (for example, an ultraviolet light sensitive ink) is provided as described above. The group code information 103, as a code, is composed of a substance or a material itself (for example, an ink or a coating material) that emits lights having different wavelength spectra in response to lights having different wavelengths. The authenticity determination means 9 has a function to perform the authenticity determination of the card 3, that is, the group information acquisition sensor 20 irradiates the group code information 103 with invisible lights having different wavelengths and receives at least two different-wavelength lights of the lights emitted from the group code information 103, and the authenticity determination means 9 determines whether the ratio of the intensities of these lights is the same. A more complex analysis with lights having two or more wavelengths may be performed by receiving lights having different wavelength spectra.

In the reading of the group code information 103, the group information acquisition sensor 20 emits two kinds of ultraviolet lights, and irradiates the group code information 103 printed on the card 3. Then, the group information acquisition sensor 20 receives lights having different wavelength spectra that are emitted by the group code information 103. The control device 14 including the authenticity determination means 9 is constituted by electronic circuits including a microcomputer, a memory and the like, and includes constitutes of an ordinary computer, as exemplified by a CPU, a ROM and a RAM. The control device 14 performs a process to determine the authenticity of the group code information 103.

Each of the following functions configures a part of the invention in the present application, as an improvement of the embodiment.

1) The present invention includes means (dealing shoe) for acquiring at least the information about each number (rank) and the number of cards in the set of several cards dealt on the game table for the use in each game, and the card disposal apparatus and the dealing shoe are connected with a communication device.

2) The present invention has an unfair-behavior check technology of comparing the rank information of each card of the card set obtained from a card dealing device (dealing shoe) and the information of each card of the disposal cards read by the card disposal apparatus, checking whether the two pieces of information coincide, and thereby checking the abnormity of the disposal card in each game.

3) The deck check means acquires the number (rank) information of the cards that remain without being used in each game after being placed on the game table, from the disposal card information acquisition means, counts the number of cards for each card number (rank), with the number (rank) information of cards of each card set that are used in each game and that have been already obtained, and checks whether all cards put in the ejection port are complete in terms of a number equivalent to a predetermined number of decks for each number (rank).

In the above, the embodiments of the present invention have been described. It is natural that the above-described embodiments can be modified within the scope of the present invention by those skilled in the art. For example, the present invention may detect an unfair behavior in games other than the baccarat. In this case, the apparatus in the embodiment may be appropriately modified, if needed in a game to which the present invention is applied.

1. A system comprising:
a housing configured to store used cards that have been pulled out of a card shoe and used in a game; and
a management device configured to detect an abnormality by comparing information on the used cards that have been used in a game with information on the used cards stored in the housing, and inspecting whether the two pieces of information match,
wherein the housing is provided with a seal configured to restrict unauthorized removal of the used cards from the housing during movement,
the housing storing the used cards has an ID code,
only authorized staff are allowed to remove the used cards from the housing.

2. The system according to claim 1, wherein the housing has an open state in which the used card can be entered and exited, and a closed state in which the stored used card cannot be removed, and
the seal is provided in the housing to maintain the housing in the closed state.

3. The system according to claim 1, wherein the housing is configured to also store unused cards that have not been pulled from the card shoe and have not been used in the game.
